(19) United States
(12) Patent Application Publication
(10) Pub. No.: US 2026/0100028 A1
(43) Pub. Date: Apr. 9, 2026

(54) MODALITY-SPECIFIC AND MODALITY-GENERIC LATENT REPRESENTATIONS

(71) Applicant: QUALCOMM Incorporated, San Diego, CA (US)

(72) Inventors: Meysam SADEGHIGOOGHARI, Linkoping (SE); Varun RAVI KUMAR, San Diego, CA (US); Senthil Kumar YOGAMANI, San Diego, CA (US)

(21) Appl. No.: 18/908,693

(22) Filed: Oct. 7, 2024

(51) Int. Cl. G06V 10/80; G01S 17/89; G06V 10/82

(52) U.S. Cl. CPC G06V 10/806; G01S 17/89; G06V 10/82

(57) ABSTRACT

Certain aspects of the present disclosure provide techniques for processing multi-modal data. Techniques may include inputting a first set of features and a second set of features into a fusion model; obtaining from the fusion model: at least one of: a first set of modality-specific features associated with a first modality; or a second set of modality-specific features associated with a second modality, wherein the first set of modality-specific features includes one or more first types of features that are distinct from one or more second types of features included in the second set of modality-specific features; and a set of modality-generic features associated with both the first modality and the second modality; and obtaining from one or more subsequent processing modules, a result based on the one or more of the first set of modality-specific features, the second set of modality-specific features, or the set of modality-generic feature.

### INTRODUCTION

### Field of the Disclosure

Aspects of the present disclosure relate to feature generation.

### DESCRIPTION OF RELATED ART

Multi-modal perception systems may refer to systems that aim to make determinations based on the surrounding environment by combining information from multiple types of sensors or input devices. Multi-modal perception systems may be used in applications such as self-driving cars, robots, and augmented reality, where a comprehensive understanding of the environment may be needed for vehicle operations and decision-making capabilities that affect the vehicle.

In some multi-modal perception systems, various sensors are used to gather different kinds of data about the environment. For example, cameras may capture visual information like images or videos, while LiDAR (Light Detection and Ranging) or radar sensors can provide data about the distance and position of objects in the surroundings. Other types of sensors may also be used, such as microphones for sound input or tactile sensors for touch feedback.

In some aspects, multi-modal perception systems may combine and make sense of the data collected from these different sensors. This process, referred to as sensor fusion (e.g., multi-modal data fusion), may allow the multi-modal perception system to create a more complete and accurate representation of the environment as opposed to based on data from only one sensor or one type of sensor. For instance, visual data from cameras can provide detailed information about the appearance and texture of objects, while range data from LiDAR can help determine the precise location and shape of those objects.

However, fusing information from different modalities may present several challenges. In some aspects, each modality may have its own unique characteristics, such as resolution, noise profile, and data format, which may make direct combination of raw data difficult. Furthermore, the increasing complexity and diversity of sensor technologies may provide additional challenges for multi-modal perception systems. As new sensors with improved capabilities become available, some multi-modal perception systems may not be able to integrate these new modalities without requiring significant modifications to the existing system architecture.

### SUMMARY

One aspect provides a method for processing multi-modal data. The method may include inputting a first set of features and a second set of features into a fusion model; obtaining as output from the fusion model: at least one of: a first set of modality-specific features associated with a first modality; or a second set of modality-specific features associated with a second modality, wherein the first set of modality-specific features includes one or more first types of features that are distinct from one or more second types of features included in the second set of modality-specific features; and a set of modality-generic features associated with both the first modality and the second modality; and obtaining, as output from one or more subsequent processing modules, a result based on the one or more of the first set of modality-specific features, the second set of modality-specific features, or the set of modality-generic feature.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example system for processing multi-modal data to obtain a modality-specific and/or a modality-generic feature, in accordance with certain aspects of the present disclosure.

FIG. 2 depicts a block diagram of an example fusion model for processing multi-modal data to obtain modality-specific features and modality-generic features, in accordance with certain aspects of the present disclosure.

FIG. 3 depicts an example attention mechanism in accordance with certain aspects of the present disclosure.

FIG. 4 depicts an example system for extracting a set of features from data associated with a modality, in accordance with certain aspects of the present disclosure.

FIG. 5 illustrates an example artificial intelligence (AI) architecture, in accordance with examples of the present disclosure.

FIG. 6 illustrates an example AI architecture of a first device that is in communication with a second device.

FIG. 7 illustrates an example artificial neural network, in accordance with examples of the present disclosure.

FIG. 8 depicts a method for processing multi-modal data to obtain modality-specific and modality-generic features, in accordance with certain aspects of the present disclosure.

FIG. 9 depicts aspects of an example processing system that can be used to implement certain aspects of the methods and systems described in this disclosure.

### DETAILED DESCRIPTION

Aspects of the present disclosure provide apparatuses, methods, processing systems, and computer-readable mediums for generating modality-specific and modality-generic features from multi-modal input data. Further, certain aspects may leverage these features for various downstream tasks, such as object detection, segmentation, object tracking, trajectory prediction, route planning, etc. Certain aspects may be described specifically with respect to multi-modal perception systems. However, it should be understood that the techniques discussed herein may be used with other types of systems, such as other types of machine learning models configured to utilize multi-modal features.

As described above, multi-modal perception systems may gather different types of data about the environment using various sensors. In some aspects, a multi-modal perception system may utilize multi-modal data to perform complex tasks such as detecting and recognizing objects, segmenting scene elements, tracking object movement, and predicting future behavior or trajectories. For example, an autonomous vehicle's multi-modal perception system may identify and tracks other vehicles, pedestrians, traffic signs, and/or obstacles, which may enable safe navigation and/or informed decision-making.

However, fusing information from different modalities may present challenges. In some aspects, each modality may have unique characteristics like resolution, noise profile, data format, or the like, making direct combination of raw data difficult. In some aspects, some features may be modality-specific, while others may be relevant across multiple modalities. For example, texture features extracted from image data may be specific to the visual modality. In contrast, other features may be modality-generic, meaning they are relevant or shared across multiple modalities. For example, geometric features such as shape or size may be derived from both visual data (e.g., images) and range data (e.g., LiDAR point clouds), making them modality-generic. In multi-modal perception systems, a feature may refer to a distinct and informative property or attribute extracted from sensor data that may capture a characteristic of the environment relevant to the multi-modal perception system's decision-making processes.

In some aspects, extracted features provide a more informative representation of raw sensor data, and may focus on aspects relevant to the multi-modal perception system's tasks. In some aspects, these features are input to algorithms or machine learning models that perform object detection, segmentation, tracking, or prediction. However, many fusion approaches fail to capture and leverage modality-specific features, potentially leading to suboptimal performance in downstream tasks. Moreover, the increasing complexity and diversity of sensor technologies may pose additional challenges for multi-modal perception systems. Integrating new sensors with improved capabilities may require significant modifications to existing system architectures.

In some aspects, techniques described herein may address these challenges by providing a fusion model that may output modality-specific and/or modality-generic features based on multi-modal input data. In some aspects, the fusion model may receive features extracted from individual modalities, apply a cross-attention mechanism to generate attention weights capturing relationships between modalities, and create modality-specific features by applying a complement of the attention weights to the original modality features. In some aspects, the fusion model may output modality-generic features by combining attended features from multiple modalities. In some aspects, the resulting features (e.g., modality-specific features and/or modality-generic features) are then provided to subsequent processing modules for downstream tasks.

In some aspects, by generating both modality-specific and modality-generic features, a fusion model may capture unique characteristics of each modality while leveraging common information across modalities, allowing downstream tasks to utilize relevant features for their specific objectives. Thus, in some aspects, a cross-attention mechanism may enable the fusion model to adapt to varying relationships between modalities across different scenarios or environments. In some aspects, the fusion model may capture and leverage (e.g., the most) relevant information from each modality based on the specific context. For example, in a well-lit environment, visual features from camera data may be more informative for object detection, while in low-light conditions, features from LiDAR or radar data may become informative. In some aspects, the cross-attention mechanism enables the fusion model to automatically adjust the importance given to each modality's features depending on their relevance in a particular situation. This adaptability helps the model combine information from different modalities and improve overall performance. In some aspects, by including separate feature extractors for each modality, additional modalities can be integrated by the fusion model and/or individual components can be replaced as sensor technologies evolve.

### Aspects Related to Generating Modality-Specific and Modality-Generic Features

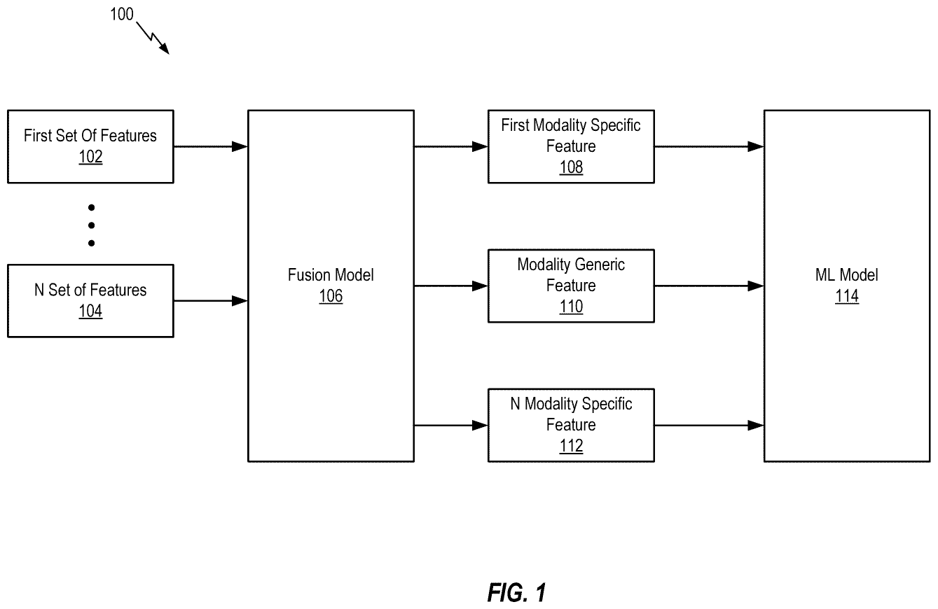

FIG. 1 depicts an example system 100 for processing multi-modal data to obtain a modality-specific and/or a modality-generic feature, in accordance with aspects of the present disclosure. In some aspects, the example system 100 may include a fusion model 106 that may receive a first set of features 102 associated with a first modality and a second set of features 104 associated with a second modality. Although two modalities are shown in the example depicted in FIG. 1, it should be understood that the fusion model 106 can accept features from any number of modalities, including two or more modalities. In some aspects, a modality may refer to a particular type or source of data that provides information about an environment or scene being observed. In certain aspects, a modality may correspond to a sensing technology or data collection method. As an example, a modality (e.g., visual modality) may refer to information obtained from an image sensor, such as but not limited to, image data. As another example, a modality (e.g., sensor modality) may refer to information obtained from a LiDAR sensor, such as but not limited to depth information. Other examples of modalities may include, but are not limited to, radar data, thermal imaging data, an acoustic signal, and/or an inertial measurement. In certain aspects, a modality can provide characteristics or information about the environment that may be different than characteristics or information about the environment provided by a different modality. For example, image data from an image sensor of a camera may provide information about at least one of an appearance, color, or texture of an object, while depth information from a LiDAR sensor may provide information about the distance and/or spatial arrangement of an object.

In some aspects, the first set of features 102 may be obtained from data associated with a first modality. For example, a set of features 102 may be obtained from image data captured by a camera and/or an image sensor. Examples of features that may be included in the first set of features 102 may include, but are not limited to, an edge feature, a color feature, a texture feature, a shape feature, and/or an object part feature. In some aspects, an edge feature may represent a boundary in an image where there is a change in pixel intensity, often indicating the separation between different regions or objects. In some aspects, a color feature may capture the distribution and relationships of pixel intensities across different color channels (e.g., RGB), which can be used to identify patterns or objects based on their color properties. In some aspects, a texture feature may refer to the repetitive pattern or variation in intensity in an image that describe the surface quality, such as smoothness, roughness, or granularity. In some aspects, a shape feature may refer to the geometric properties or outline of an object in an image, such as circles, rectangles, or other structural forms. In some aspects, an object part feature may identify distinct components of an object, such as a wheel on a car or an eye on a face, which may be used identify the entirety of an object. Of course, other features than those described above may be included in the first set of features 102.

In some aspects, the first set of features 102 may be obtained from a feature extractor that extracts relevant features from the image data. In some aspects, the feature extractor may be implemented using one or more various techniques, such as an encoder, which may map input data to a lower-dimensional representation. One example of an encoder is a convolutional neural network (CNN). In a CNN, features may be learned at different levels of abstraction as data passes through layers of the network. In some aspects, early layers of the CNN may learn low-level features, such as edges, colors, and textures, which capture more basic and fundamental characteristics of an image. In some aspects, as data progresses through intermediate layers of the CNN, the CNN may combine the low-level features into more complex patterns and structures, forming mid-level features such as shapes and object parts. In some aspects, deeper layers of the CNN may learn high-level features, which may represent more abstract information about an image, such as entire objects and scene contexts.

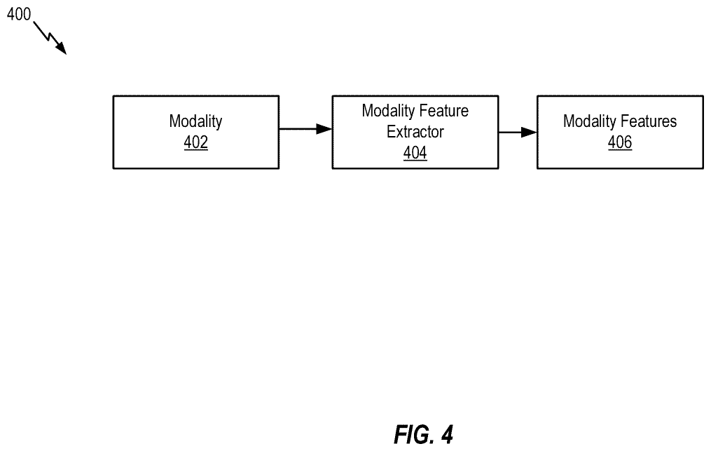

In some aspects, the aforementioned features (e.g., edges, colors, textures, shapes, object parts, or the like) can be considered as different types of features, each capturing a specific aspect or characteristic of the image data at one or more various levels of abstraction within the encoder. In some aspects, a type of feature may be categorized into a low-level type of feature (e.g., edges, colors, textures), mid-level type of feature (e.g., shapes, object parts), or high-level type of feature (e.g., objects, scene contexts). Other suitable feature extraction techniques, such as scale-invariant feature transform (SIFT), may also be employed to obtain the first set of features 102, as will be further described with respect to FIG. 4.

In some aspects, the second set of features 104, also referred to as the Nth set of features where N represents any additional modality beyond the first modality, may represent features obtained from data associated with a second modality or any additional modality beyond the first modality. In some aspects, a second modality may refer to a particular type or source of data that provides information about the environment or scene being observed. In certain aspects, a second modality may be any type of sensor or data source that provides complementary information to a first modality associated with the first set of features 102. In some aspects, complementary information may refer to data that offers additional or unique insights about the environment or scene, which may not be captured by the first modality alone. For example, the second modality may correspond to one or more of a depth sensor, thermal camera, acoustic sensor, and/or inertial measurement unit. As another example, the second modality may correspond to information obtained from one or more of the depth sensor, thermal camera, acoustic sensor, and/or inertial measurement unit. Thus, in aspects where the second modality includes depth information associated with a LiDAR sensor, the second set of features 104 may include features associated with a distance measurement, point cloud data, or a 3D spatial relationship between objects in the scene. As another example, if the second modality corresponds to thermal imaging, the second set of features may capture a temperature distribution and/or thermal property of an object. In some aspects, and similar to the first set of features 102, the second set of features 104 may be obtained by applying a feature extraction technique to data associated with the second modality.

In some aspects, the second set of features 104 is input to the fusion model 106, alongside the first set of features 102. In some aspects, the fusion model 106 may process these first set of features 102 and the second set of features 104 and output a modality-specific feature (e.g., at least one of a first modality-specific feature 108 and/or n modality-specific feature 112) and a modality-generic feature that may represent unique characteristics and complementary information from each of the modalities. In some aspects, a modality-specific feature (e.g., first modality-specific feature 108 and/or N modality-specific feature 112, where N represents the second modality or any additional modality beyond the first modality) may capture a unique characteristic and/or pattern specific to each modality, while the modality-generic feature 110 may represent the common information (e.g., features) shared across multiple modalities.

In some aspects, the first modality-specific feature 108 may be derived from the first set of features 102 and may represent a distinctive aspect of the first modality that is not present in other modalities. For example, a first modality-specific feature 108 may include fine-grained details, such as text or texture information, that is specific to image data. In some aspects, the second modality-specific feature 112 may be derived from the second set of features 104 and may represent unique characteristic associated with a second modality. For example, if the second modality represents depth information from LiDAR sensors, the second modality-specific feature 112 may include a distance measurement or 3D spatial relationship between objects in a scene.

In some aspects, the first modality-specific feature 108 may refer to a first set of modality-specific features associated with the first modality, while the second modality-specific feature 112 may refer to a second set of modality-specific features associated with the second modality. In some aspects, the first set of modality-specific features includes one or more first types of features that are distinct from one or more second types of features included in the second set of modality-specific features. For example, if the first modality is associated with image data from a camera and the second modality is associated with depth information from a LiDAR sensor, the first set of modality-specific features may include at least one of color, texture, or shape features that are specific to the image data, while the second set of modality-specific features may include at least one of distance measurements or 3D spatial relationships that are specific to the depth information.

In some aspects, the modality-generic feature 110 represents information that may be common to two or more modalities. In some aspects, a modality-generic feature 110 may represent high-level semantic understanding of a scene, such as the presence and location of an object. The modality-generic feature 110 may be obtained by fusing information from two or more modalities, which allows the fusion model 106 to utilize the complementary nature of different data sources.

In some aspects, a machine learning model 114 may receive the modality-specific features (e.g., at least one of first modality-specific feature 108 or the second modality-specific feature 112) and the modality-generic feature 110 as inputs for further processing and analysis. In some aspects, the machine learning model 114 may perform one or more of an object detection task, a segmentation task, a prediction and planning task, a tracking task, or other suitable task depending on a specific application.

As an example, and to further illustrate various aspects of the fusion model 106 within the context of an autonomous driving scenario involving a stop sign, a first modality may correspond to image data captured by an image sensor of a camera and a second modality may correspond to depth information obtained from a LiDAR sensor. In some aspects, the first set of features 102 may be extracted from the image data and may include one or more characteristics associated with the image. Such features may include but are not limited to, the color (red), shape (octagonal), and text (“STOP”) of the stop sign. In some examples, these features may be obtained using one or more feature extraction techniques such as CNN or SIFT as previously described.

Continuing with the autonomous driving example involving a stop sign, the second set of features 104 may be extracted from the data associated with a LiDAR sensor and may include depth information, such as a distance of the stop sign from a sensor and the 3D spatial location of the stop sign in the scene. The second set of features 104 may provide complementary information to the image data and enhance an overall understanding of the stop sign's position and surrounding environment.

In examples, the fusion model 106 may process the first set of features 102 from the image data and the second set of features 104 from the LiDAR data to output a modality-specific feature and a modality-generic feature. In some aspects, the fusion model 106 may employ techniques including at least one of cross-attention mechanisms or feature concatenation to combine information (e.g., features) from both modalities. The first modality-specific feature 108, derived from the first set of features 102, may capture visual-specific details of the stop sign, such as its color and the text “STOP” written on it. In certain aspects, the first modality-specific feature 108 may emphasize a distinctive aspect of image data that may not be directly captured by or represented by the LiDAR data.

For example, the first modality-specific feature 108 may include a type of feature, such as text-based features, that captures the presence and content of text in the image, such as but not limited to, the characters “S”, “T”, “O”, and “P” on the stop sign. In some examples, a specific text-based features may include a feature that indicates the presence of each individual letter in the image. As another example, a type of feature may refer to color-based features that may capture the dominant colors in the image, such as but not limited to, the red color of the stop sign, with a specific feature indicating the presence of the color red or the dominant red hue value for example. As another example, a type of feature may refer to texture-based features that may capture a visual texture pattern on the surface of the stop sign, such as the granularity of the paint or the reflective coating, with a specific feature including, but not limited to, a feature indicating granularity or a reflectivity measure. As another example, a type of feature may refer to an edge-based feature that may capture a sharp edge and/or contour of the stop sign's shape as seen in the image, with a specific feature including the presence of a sharp edge forming an octagonal shape or the contrast between the stop sign edge and the background.

In some examples, the second modality-specific feature 112, derived from the second set of features 104, may include a type of feature, such as but not limited to, shape-based, reflectivity-based, point density-based, or a surface normal-based feature that may capture a characteristic of the LiDAR data, providing information that may not be available implicitly or explicitly in the image data. In some examples, a type of feature may refer to a shape-based feature that may capture a 3D shape characteristic of the stop sign, such as its octagonal shape or flat surface, with a specific feature including a feature such as, but not limited to, the presence of an octagonal 3D shape and a flatness measure of the stop sign's surface. As another example, a type of feature may refer to a reflectivity-based feature that may capture a reflectivity property of the stop sign's surface, which can help distinguish it from other objects in the scene. An example of a specific reflectivity-based feature may include, but is not limited to, the average reflectivity value of the stop sign's surface and the contrast in reflectivity between the stop sign and a surrounding object.

As another example, a type of feature may refer to a point density-based feature that may capture the density of LiDAR points at the surface of the stop sign, which can indicate its distance and orientation relative to the sensor. A specific feature may include, but is not limited to, the number of LiDAR points on the stop sign's surface or the density ratio of points on the stop sign compared to the background. In some examples, a type of feature may refer to surface normal-based features that may capture the direction of the surface normal of the stop sign, which can help distinguish it from other flat surfaces in the scene. Examples of a specific feature includes, but is not limited to, the consistency of surface normals across the stop sign's surface or the deviation of surface normals from the expected orientation of a stop sign.

In some aspects, the modality-generic feature 110 may represent common information (e.g., features) shared across multiple modalities. In the case of the stop sign, the modality-generic feature 110 may include a feature that captures the high-level semantic understanding of the stop sign that is consistent across both the image data associated with the first modality and the depth data associated with the second modality.

For example, the modality-generic feature 110 may include a spatial location feature that indicates the presence and/or location of the stop sign in the scene, such as its 3D coordinates or its relative position with respect to other objects in the environment. Additionally, the modality-generic feature 110 may include a size feature that captures the overall dimensions of the stop sign, such as its height, width, or depth, which may be estimated from both the image data and the LiDAR data. In some examples, a shape feature, such as the octagonal shape of the stop sign, may also be included in the modality-generic feature 110, as this characteristic may be observable in both modalities. In certain aspects, a contextual feature that describes the relationship between the stop sign and another object in the scene, such as its proximity to the road or other traffic signs, may be captured in the modality-generic feature 110. In certain aspects, the modality-generic feature 110 provides a high-level, cross-modal understanding of the stop sign that is not specific to any single modality but rather represents the common information shared between them.

In some aspects, the example of a modality-generic feature 110, such as the shape or location of the stop sign, may overlap with an example of a modality-specific feature (e.g., 108, 112). In certain aspects, this overlap may reflect the way in which the fusion model 106 combines and abstracts information captured by the modality-specific features to derive a high-level, cross-modal understanding of the object. The modality-generic feature 110 may capture the common aspects of the stop sign that are consistent across both the image data associated with the first modality and the depth data associated with the second modality, even if these aspects are also captured by the modality-specific features in different ways.

For example, the modality-generic feature 110 may include a spatial location feature that indicates the presence and/or location of the stop sign in the scene, a size feature that captures the overall dimensions of the stop sign, a shape feature that represents the octagonal shape of the stop sign, and/or a contextual feature that describes the relationship between the stop sign and another object in the scene. In some aspects, these example features provide a high-level, cross-modal understanding of the stop sign that may complement a unique aspect of the stop sign as captured by the modality-specific feature, which may enable the fusion model to effectively make determinations about the presence and property of the stop sign in the scene.

The machine learning model 114, which may be an object detection model in an example, may receive a modality-specific feature (e.g., the first modality-specific feature 108 and/or the second modality-specific feature 112) and the modality-generic feature 110 as inputs. The machine learning model 114 may then utilize these separately provided features to detect and localize the stop sign in the scene. For example, by leveraging the combination of modality-specific and modality-generic features, the machine learning model 114 can identify the stop sign based on its visual appearance, confirm its presence using the depth information, and localize it accurately in the 3D space.

As another example, the machine learning model 114 may project the detected stop sign into a bird's-eye-view (BEV) space, providing a top-down perspective of the scene. In some aspects, this representation may be used for autonomous driving tasks, as it may allow a system to determine the spatial relationship between the stop sign and other objects in the environment.

### Aspects Related to a Fusion Model

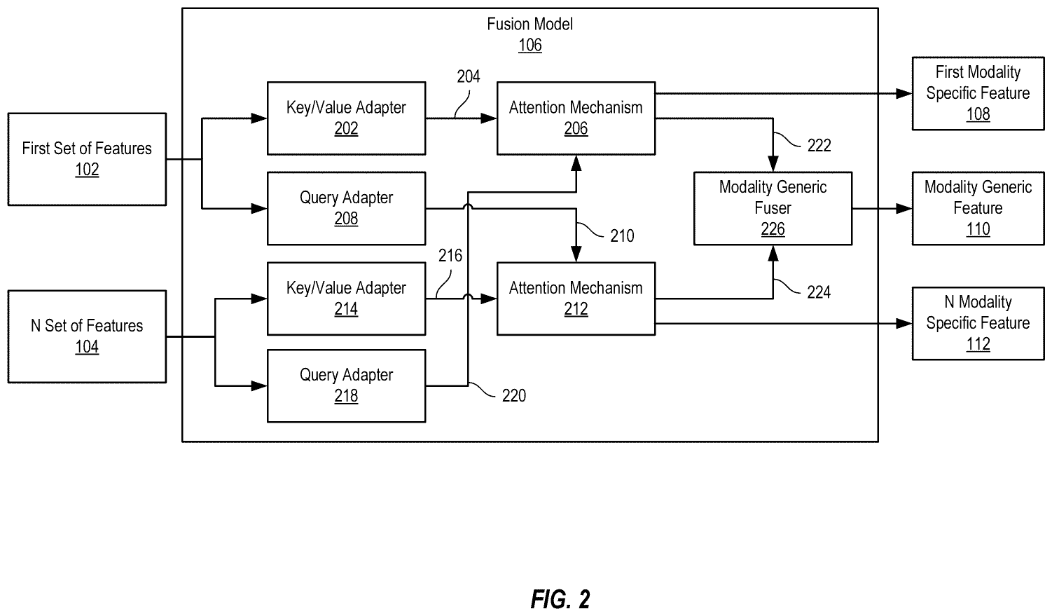

FIG. 2 illustrates a block diagram of an example fusion model 106 for processing multi-modal data to obtain modality-specific features and modality-generic features, in accordance with aspects of the present disclosure. In some aspects, the fusion model 106 may receive a first set of features 102 associated with a first modality and a second set of features 104 associated with a second modality. Although two modalities are shown in this example, it should be understood that the fusion model 106 can accept and process features from any number of modalities, including two or more modalities. In some aspects, the fusion model 106 may process the first set of features 102 and the second set of features 104 to output a first modality-specific feature 108, a second modality-specific feature 112, and a modality-generic feature 110 as previously described.

In some aspects, the fusion model 106 may include a key/value adapter 202 that processes the first set of features 102 to generate keys/values 204. The key/value adapter 202 may apply a linear transformation to the first set of features 102, denoted as F₁ below, using learned weight matrices W_{K1} and W_{V1} to compute the keys K₁ and values V₁:

$${K}_{1} = {F}_{1} \times {W}_{K 1}$$

$${V}_{1} = {F}_{1} \times {W}_{V 1}$$

In some aspects, the learned weight matrices W_{K1} and W_{V1} may be obtained through a training process, which is described in more detail below. In some aspects, the fusion model 106 may also include a query adapter 218 that processes the second set of features 104 to generate a set of queries 220. The query adapter 218 may apply a linear transformation to the second set of features 104, denoted as F₂ below, using a learned weight matrix W_{Q2} to compute the queries Q₂:

$${Q}_{2} = {F}_{2} \times {W}_{Q 2}$$

In some aspects, the learned weight matrix W_{Q2} may be obtained through a training process, which is described in more detail below. In some aspects, the attention mechanism 206 receives the keys K₁ and values V₁ from the key/value adapter 202, and the queries Q₂ from the query adapter 218. In some aspects, the attention mechanism 206 computes the similarity between the queries Q₂ and the keys K₁ to generate a set of attention weights. In some aspects, the similarity may be computed using a dot product operation that calculates the dot product between each query in Q₂ and each key in K₁. In some aspects, the attention weights are then used to compute a weighted sum of the values V₁, resulting in a set of attended features that capture the information from the first modality that is relevant to the second modality.

In some aspects, the fusion model 106 further includes a key/value adapter 214 that processes the second set of features 104 to generate keys/values 216. In some aspects, the key/value adapter 214 applies linear transformations using learned weight matrices W_{K2} and W_{V2} to generate keys K₂ and values V₂:

$${K}_{2} = {F}_{2} \times {W}_{K 2}$$

$${V}_{2} = {F}_{2} \times {W}_{V 2}$$

In some aspects, the learned weight matrices W_{K2} and W_{V2} may be obtained through a training process, which is described in more detail below. In some aspects, the fusion model 106 may include a query adapter 208 that processes the first set of features 102 to generate a set of queries 210. In some aspects, the query adapter 208 applies a linear transformation using a learned weight matrix W_{Q1} to generate queries Q₁:

$${Q}_{1} = {F}_{1} \times {W}_{Q 1}$$

In some aspects, the learned weight matrices W_{Q1} may be obtained through a training process, which is described in more detail below. In some aspects, the keys K₂, values V₂, and queries Q₁ may then be used by an attention mechanism 212 to generate a set of attended features that capture the information from the second modality that is relevant to the first modality.

In some aspects, the attended features from the attention mechanism 206 may be passed through a complement operation to generate the first modality-specific feature 108, which may capture the unique characteristics of the first modality. Similarly, and in some aspects, the attended features from the attention mechanism 212 may be passed through a complement operation to generate the second modality-specific feature 112, which may capture the unique characteristics of the second modality.

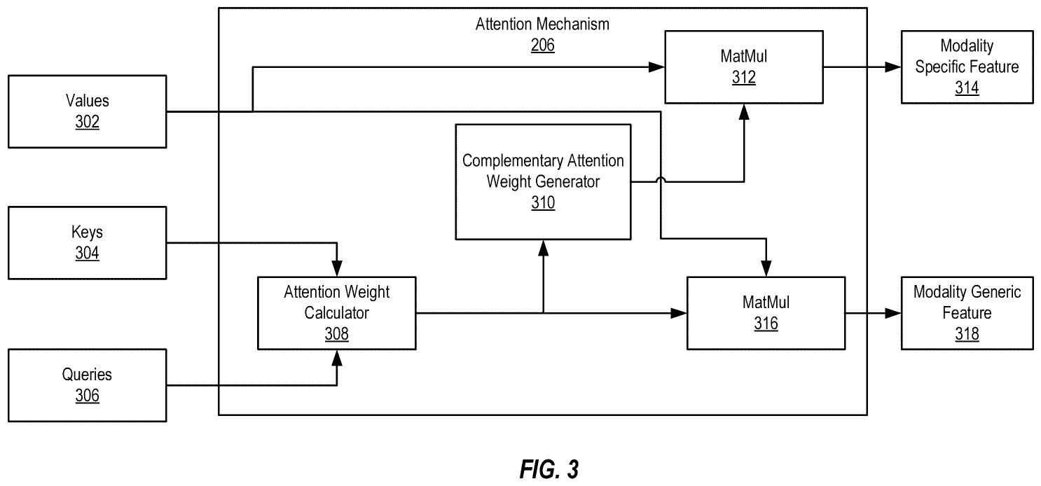

In some aspects, the attended features from the attention mechanism 206 may be used to generate a set of first modality-generic features 222, which represent the common information (e.g., features) shared between the first modality and the second modality. Similarly, and in some aspects, the attended features from the attention mechanism 212 may be used to generate a set of second modality-generic features 224. Additional details describing a process of generating the modality-generic features from the attended features is described in more detail with respect to FIG. 3 below.

In some aspects, the first modality-generic features 222 and the second modality-generic features 224 may be processed by a modality-generic fuser 226 to obtain a modality-generic feature 110. In some aspects, the modality-generic fuser 226 may include a neural network layer, such as a fully connected layer or a convolutional layer, that combines the first modality-generic features 222 and the second modality-generic features 224 to generate a fused representation that captures the common information (e.g., features) shared across the modalities.

In some aspects, the learned weight matrices used in the key/value adapters (202 and 214) and query adapters (208 and 218) may be obtained through a training process. In some aspects, and during training, the fusion model 106 may receive a dataset that includes paired examples of the first set of features 102 and the second set of features 104, along with corresponding ground truth labels or target outputs for a machine learning task, such as object detection or scene understanding task.

In some aspects, the training process may optimize the learned weight matrices (W_{K1}, W_{V1}, W_{Q1}, W_{K2}, W_{V2}, and W_{Q2}) to minimize a loss function that measures a difference between the predicted outputs of the fusion model 106 and the provided ground truth labels. In some aspects, the predicted outputs depend on the specific task the fusion model 106 is configured to perform. For example, in an object detection task, the predicted outputs could be the bounding box coordinates and class labels of the detected objects in the input data. As another example, in a semantic segmentation task, the predicted outputs could be the pixel-wise class labels assigned to each pixel in the input image. As another example, in a classification task, the predicted outputs could be the class probabilities for each input sample. In some aspects, the loss function is selected based on the task and the desired output format, such as cross-entropy loss for classification tasks or mean squared error for regression tasks. In some aspects, optimization may be performed using gradient-based methods, such as stochastic gradient descent (SGD) or other variants like Adam or AdaGrad, which may iteratively update the weight matrices in a direction that minimizes the selected loss function. In some aspects, the optimization iteration may be repeated over multiple epochs until the fusion model 106 converges to a state where the fusion model 106 can predict the desired outputs for the given input data in accordance with an accuracy threshold.

In some aspects, and during each training iteration, the fusion model 106 may process a batch of paired examples from the training dataset. In certain aspects, the first set of features 102 and the second set of features 104 may be passed through respective key/value adapters (e.g., 202, 208) and query adapters (e.g., 214, 218), and the resulting keys and values (e.g., 204, 216), and queries (e.g., 210, 220) may be used by the attention mechanisms (e.g., 206, 212) to generate attended features. In some aspects, the attended features may then be used to obtain the modality-specific features (e.g., 108, 112) and the modality-generic features (e.g., 222, 224), which may be fused by the modality-generic fuser 226, which may output the modality-generic feature 110.

In some aspects, the modality-specific and modality-generic features output by the fusion model 106 may be compared against ground truth labels using a loss function, and gradients of the loss with respect to the learned weight matrices may be obtained using backpropagation. Such gradients may be used to update the weight matrices in a direction that minimizes the loss, using a selected gradient-based method.

In some aspects, the training process may be repeated for a large number of iterations, with the learned weight matrices being updated incrementally based on each iteration according to the gradients of the loss. In some examples, as training progresses, the fusion model 106 learns to extract more informative and discriminative features from the data associated with the input modalities and combine these extracted features to generate accurate predictions for the target task. In some aspects, upon completing the training process, the learned weight matrices may be fixed and then used to process new, unseen examples during an inference operation.

### Aspects Related to an Attention Mechanism

FIG. 3 depicts an example attention mechanism 206, in accordance with aspects of the present disclosure. In some aspects, the attention mechanism 206 may receive values 302, keys 304, and queries 306. In some aspects, the values 302 and keys 304 may correspond to the keys/values 204 as described with reference to FIG. 2. Similarly, in some aspects, the queries 306 may correspond to the queries 220, as described with reference to FIG. 2. That is, the values 302 and the keys 304 may be based on a first set of features associated with a first modality (e.g., first set of features 102) while the queries 306 may be based on a different set of features associated with a different modality (e.g., N set of features 104), enabling cross-modal attention computation.

In some aspects, the values 302, keys 304, and queries 306 may be input to an attention weight calculator 308. In some aspects, the attention weight calculator 308 may generate a set of attention weights based on a similarity function applied between the queries 306 and the keys 304. For example, the similarity function may include a dot product operation that computes the similarity between each query in the queries 306 and each key in the keys 304, followed by a softmax function that normalizes the attention weights. The attention weights (w) may be computed according to:

$$w = softmax ( \frac{{QK}^{T}}{\sqrt{{d}_{K}}} )$$

where Q represents the queries 306, K represents the keys 304, dk represents the dimension of the keys, and softmax represents the softmax function that normalizes dot product results to obtain the attention weights w. In some aspects, the resulting attention weights from the attention weight calculator 308 may indicate how much focus to place on different values in the values 302 when generating an output, such as an attended feature vector. In some aspects, an attended feature vector may be a weighted combination of the values 302, where the weights are determined by the attention weights, emphasizing the more relevant features for the given queries 306.

In some aspects, other similarity functions or methods may be used to generate the attention weights in the attention weight calculator 308. For example, the attention weights may be generated using a cosine similarity function, which may measure the cosine of the angle between the query and key vectors. In some aspects, the attention weights may be generated using a learned neural network layer that takes the queries 306 and keys 304 as inputs and outputs the attention weights directly.

In some aspects, the attention weights from the attention weight calculator 308 may be passed to a complementary attention weight generator 310. In some aspects, the complementary attention weight generator 310 may generate a set of complementary attention weights based on the attention weights from the attention weight calculator 308. The complementary attention weights may represent an inverse relationship between the attention weights and a residual attention capacity. In some aspects, the residual attention capacity may refer to the remaining attention resources that are not assigned by the original attention weights. In other words, the residual attention capacity may represent the attention capacity that is not utilized or captured by the attention weights generated from the queries 306 and keys 304. In some aspects, the complementary attention weights may allocate the residual attention capacity to the values 302, allowing a downstream model to focus on features or information that may not have been emphasized by the original attention weights generated by the attention weight calculator 308. In some aspects, the complementary attention weights (we) can be generated according to:

$${w}_{c} = 1 - w$$

where w may represent the attention weights obtained from the attention weight calculator 308. In some aspects, each attention weight is subtracted from 1 to obtain the complementary attention weights, which capture the remaining attention capacity not assigned by the original attention weights. In some aspects, a maximum attention capacity of 1 represents a scenario where all the attention resources are allocated. For example, if an attention weight is 0.7, the complementary attention weight would be 0.3, indicating that 30% of the attention capacity is still available to be assigned to other features or information.

In some aspects, residual attention capacity can be thought of as the ‘leftover’ attention that is not assigned by the original attention weights. For example, assume there exists a fixed budget of attention to allocate to different features. In some aspects, the attention weights generated by the attention weight calculator 308 may assign a portion of this budget to each feature based on their relevance to the queries. Accordingly, the residual attention capacity may represent the remaining budget that hasn't been allocated. In some aspects, the complementary attention weights may redistribute this leftover attention to features that may not have been heavily weighted by the original attention weights, allowing a downstream model to consider features that might have been overlooked thereby providing a more comprehensive representation of the input data.

In some aspects, the complementary attention weights we from the complementary attention weight generator 310 may be applied to the values 302 using a matrix multiplication (MATMUL) operation 312. In some aspects, the result of the MATMUL operation 312 may correspond to a modality-specific feature 314. In some aspects, the modality-specific feature 314 may capture unique characteristics or patterns that are specific to the modality associated with the values 302. For example, if the values 302 are derived from a first modality, such as image data, the modality-specific feature 314 may represent visual features that are distinct from features associated with other modalities. For example, if the values 302 are derived from image data, the modality-specific features 314 may represent visual characteristics such as texture, color, or shape that are unique to the image modality. In some aspects, the modality-specific feature 314 may correspond to the first modality-specific feature 108 of FIG. 1. However, in some aspects, the values 302 may be associated with audio data such that the modality-specific feature 314 may represent pitch, tone, or rhythm patterns that are specific to an audio modality. In some aspects, the modality-specific features may emphasize the distinct properties of each modality.

For example, if the input values are derived from image data, the modality-specific features might capture visual characteristics such as texture, color, or shape that are unique to the image modality. If the input values come from audio data, the modality-specific features could represent pitch, tone, or rhythm patterns that are specific to the audio modality. These modality-specific features may help preserve and highlight the distinct properties of each modality, which may assist the model to process and interpret data from different sources.

In some aspects, in addition to generating the modality-specific feature 314, the attention mechanism 206 may also generate a modality-generic feature 318, where the modality-generic feature 318 may correspond to the modality-generic feature 110 of FIG. 1. In some aspects, the modality-generic feature 318 may be obtained by applying the attention weights from the attention weight calculator 308 to the values 302 using another MATMUL operation 316. The modality-generic feature 318 may represent common information or features that are shared across multiple modalities. For example, the modality-generic feature 318 may capture high-level semantic understanding of a scene, such as the presence and location of objects, which can be derived from different modalities like image data and depth information.

### Aspects Related to Extracting Features Using a Feature Extractor

FIG. 4 illustrates an example system 400 for extracting a set of features from data associated with a modality, in accordance with aspects of the present disclosure. In some aspects, the example system 400 may include a modality 402, a modality feature extractor 404, and a set of features 406 obtained from data associated with the modality 402.

In some aspects, the modality 402 may refer to a particular type or source of data that provides information about an environment or scene being observed. The modality 402 may correspond to a sensing technology or data collection method. For example, the modality 402 may include, but is not limited to, image data from an image sensor, depth information from a LiDAR sensor, radar data, thermal imaging data, an acoustic signal, and/or an inertial measurement.

In some aspects, the modality 402 may provide characteristics or information about the environment that are specific to that modality. For instance, image data from an image sensor of a camera may provide information about at least one of an appearance, color, or texture of an object in the environment, while depth information from a LiDAR sensor may provide information about the distance or depth of the object from the LiDAR sensor.

In some aspects, the modality feature extractor 404 may receive the modality 402 as input and process it to extract a set of features 406. The modality feature extractor 404 may include one or more neural network layers, such as convolutional layers, fully connected layers, and/or recurrent layers, that are configured to learn and extract relevant features from the modality 402.

In some aspects, the modality feature extractor 404 may be trained on a dataset of examples from the modality 402 to learn discriminative features that capture the unique characteristics and patterns specific to that modality. For example, if the modality 402 corresponds to image data, the modality feature extractor 404 may be trained on a dataset of images to learn visual features such as edges, textures, shapes, and object appearances. Similarly, if the modality 402 corresponds to LiDAR data, the modality feature extractor 404 may be trained to learn geometric features such as surfaces, edges, and 3D structures from the point cloud data.

In some aspects, the output of the modality feature extractor 404 is a set of features 406 obtained from data associated with the modality 402. The set of features 406 may represent the salient information and patterns specific to the modality 402. In some aspects, the set of features 406 may be provided as input to the fusion model 106, as described in FIG. 1, for further processing and generation of modality-specific features and modality-generic features.

### Example Artificial Intelligence System for Obtaining Modality-Specific and Modality-Generic Features

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

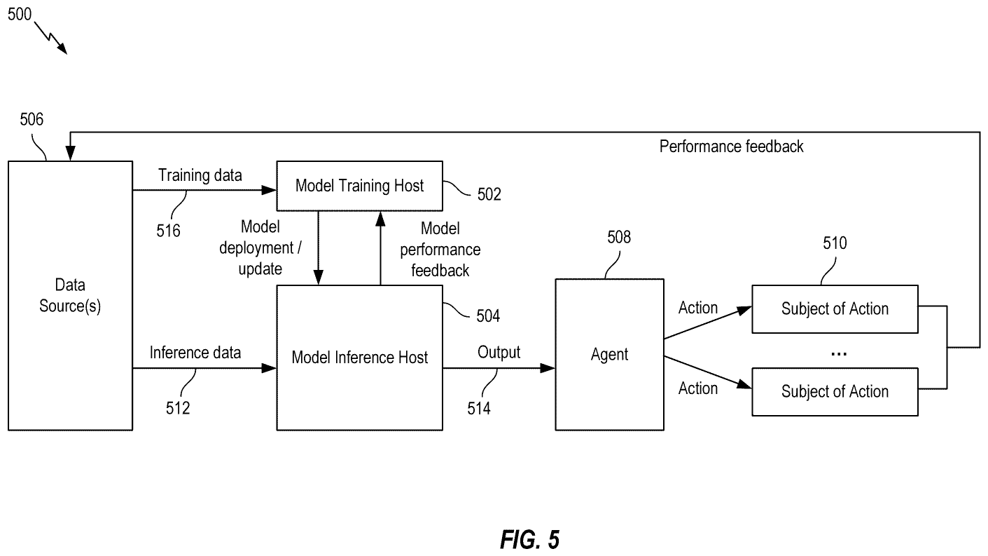

FIG. 5 is a diagram illustrating an example AI architecture 500 that may be used to implement the machine learning models and feature generation techniques described in this disclosure. As illustrated, the architecture 500 includes multiple logical entities, such as a model training host 502 for training the machine learning model to generate modality-specific and modality-generic features, a model inference host 504 for running inference using the trained model, data source(s) 506 providing training and inference data, and an agent 508 that utilizes the model's output. This AI architecture could be used to enable the example disclosed feature generation techniques in various machine learning applications.

The model inference host 504, in the architecture 500, is configured to run an ML model based on inference data 512 provided by data source(s) 506. The model inference host 504 may produce an output 514 (e.g., modality-specific features and modality-generic features) based on the inference data 512, that is then provided as input to the agent 508.

The agent 508 may be an element or entity that utilizes the output of the machine learning model hosted by the model inference host 504. The agent 508 could be a software component, a hardware accelerator, or a system that leverages the modality-specific and modality-generic features produced by the model for various downstream tasks such as object detection, segmentation, scene understanding, or other perception problems.

For example, if the output 514 from the model inference host 504 includes modality-specific features obtained from image and LiDAR data, the agent 508 may be an autonomous driving system that uses the features for detecting objects and making determinations based on the surrounding environment. As another example, if the output 514 contains modality-generic features that capture information shared across multiple sensor modalities, the agent 508 could be a sensor fusion module.

After receiving the output 514 from the model inference host 504, the agent 508 may determine how to utilize it. For instance, if the agent 508 is an autonomous driving system and the output includes modality-specific visual and LiDAR features, it may use the visual features for lane detection and the LiDAR features for obstacle avoidance. If the agent 508 decides to use the output 514, it may apply it to the subject of the action 510, which represents the data being processed or enhanced. In the autonomous driving example, the subject of action 510 would be the vehicle's perception and control systems. In some cases, the agent 508 and subject of action 510 may be tightly integrated.

The data sources 506 may be configured to collect data used as training data 516 for the model training host 502 to train the feature generation machine learning models. The data sources 506 may also provide inference data 512 to the model inference host 504. This data could come from various entities and may include the subject of action 510. For example, for training a model to generate modality-specific and modality-generic features, the data sources 506 may collect synchronized image, LiDAR, and radar data. The model training host 502 can then monitor the model's performance on this data to determine if retraining or fine-tuning is necessary to improve the quality of the generated features. In some cases, the agent 508 and the subject of action 510 are the same entity.

The data sources 506 may be configured for collecting data that is used as training data 516 for training the machine learning model to generate modality-specific and generic features. The data sources 506 may also provide inference data 512 (also referred to as input data) for feeding the trained model during inference. In particular, the data sources 506 may collect data from multiple sensor modalities, such as cameras, LiDAR, and radar. This data may come from various sources, including the subject of action 510, which represents the data being processed by the model. The collected data is provided to the model training host 502 for training and fine-tuning the feature generation model. For example, after the subject of action 510 (e.g., a set of frames including image and/or LiDAR frames) is processed by the model, the output 514 (e.g., predicted modality-specific and modality-generic features) may be compared to ground truth data to evaluate the model's performance. If the output 514 is not sufficiently informative or discriminative, this performance feedback may be used by the model training host 502 to further train the model, aiming to improve the quality of the generated features. The updated model may then be deployed to the model inference host 504.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

In some aspects, a machine learning model for generating modality-specific and generic features is deployed at or on a computing device for enhancing the performance of perception tasks. More specifically, a model inference host, such as model inference host 504 in FIG. 5, may be deployed at or on the computing device for running the feature generation model to extract informative representations and improve accuracy.

In some other aspects, the feature generation machine learning model is deployed at or on an embedded system or mobile device for enabling efficient on-device inference. More specifically, a model inference host, such as model inference host 504 in FIG. 5, may be deployed at or on the embedded system or mobile device for running the model to obtain high-quality modality-specific and modality-generic features while meeting resource constraints.

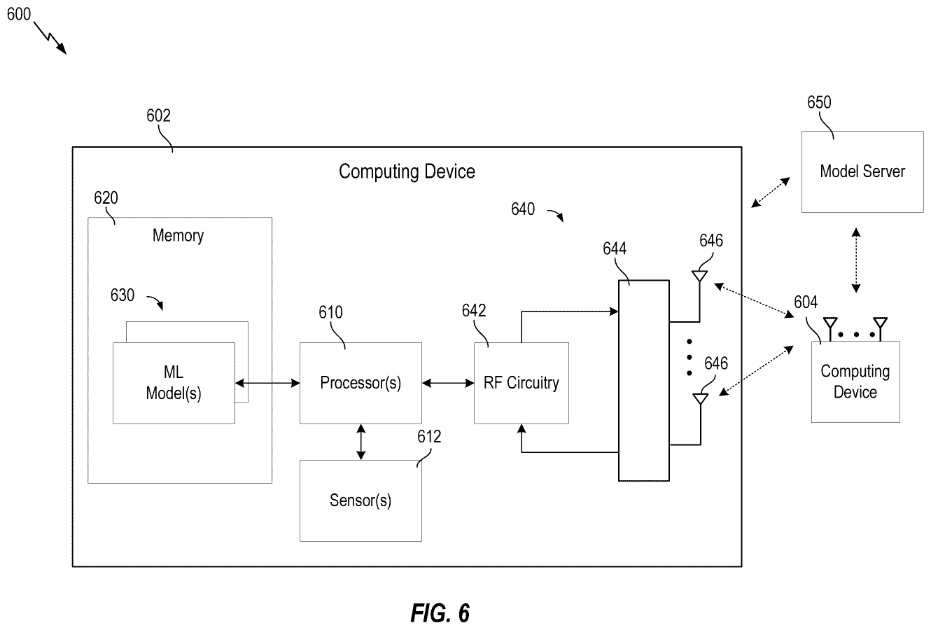

FIG. 6 illustrates an example AI architecture 600 of a first computing device 602 that may be in communication with a second computing device 604. The first computing device 602 may be a server or cloud computing platform as described herein with respect to FIG. 5. Similarly, the second computing device 604 may be an embedded system or mobile device as described herein with respect to FIG. 5. In some examples, the first computing device 602 may be incorporated into or otherwise part of a vehicle, robot, or other device. Note that the AI architecture of the first computing device 602 may be applied to the second computing device 604.

The first computing device 602 may be, or may include, a chip, system on chip (SoC), a system in package (SiP), chipset, package or device that includes one or more processors, processing blocks or processing elements (collectively “the processor 610”) and one or more memory blocks or elements (collectively “the memory 620”).

As an example, in a model inference mode, the processor 610 may transform input data from multiple modalities (e.g., images, LiDAR point clouds) into a format suitable for the fusion model. The processor 610 may then run the model on the formatted input data to generate modality-specific features and modality-generic features. The processor 610 may be coupled to an optional transceiver 640 for transmitting and/or receiving signals via one or more antennas 646, where the signals may be associated with input data from one or more optionally connected second computing devices 604. The transceiver 640 may include interface circuitry 642 and 644 for converting between the digital signals of the processor and any transmission protocol used by the antenna 646.

When receiving input data via the antenna 646 (e.g., from the second computing device 604), the transceiver interface circuitry 642 and 644 may convert the received signals to a baseband frequency and then to digital signals for processing by the processor 610. The processor 610 may format the digital input signals and feed them into the fusion model for obtaining modality-specific and modality-generic features. Although shown as included in the first computing device 602, the transceiver 640, interface circuitry 642 and 644, antenna 646, and second computing device 604 may be optionally included.

In some aspects, sensor(s) 612 may be coupled to the processor 610. In some aspects, the sensors(s) 612 may include, but are not limited to, a camera(s), LiDAR sensor(s), radar sensor(s), inertial measurement unit(s), GPS receiver(s), and/or any other type of sensor capable of capturing data from an environment. The sensor(s) 612 may provide raw senor data to the processor 610, which may then process and format the sensor data into a format for input into the ML model 630 (e.g., fusion model 106). The ML model 630 may utilize the processed sensor data along with data from other modalities to generate a modality-specific and/or a modality-generic feature as previously described.

One or more ML models 630 may be stored in the memory 620 and accessible to the processor 610. In certain cases, different ML models 630 with different characteristics may be stored in the memory 620, and a particular ML model 630 may be selected based on its characteristics and/or application as well as characteristics and/or conditions of first computing device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the output features, different latencies (e.g., processing times of less than 10 ms, 100 ms, or 1 second) associated with producing the features, different ML model sizes (e.g., file sizes), different coefficients or weights, etc.

The processor 610 may use the ML model 630 to produce output data (e.g., modality-specific features and modality-generic features) based on input data from multiple modalities, for example, as described herein with respect to the inference host 504 of FIG. 5. The ML model 630 may be used to perform any of various AI-enhanced tasks, such as those listed above.

As an example, the ML model 630 may take input data from multiple modalities, such as RGB images and LiDAR point clouds, to obtain modality-specific features that capture the unique characteristics of each modality, as well as modality-generic features that represent the shared information across modalities. The input data may include, for example, raw sensor measurements from cameras and LiDARs, or pre-processed representations such as image features and point cloud descriptors. The output data may include, for example, a set of modality-specific feature vectors that encode the distinctive patterns in each input modality, and a modality-generic feature vector that captures the common semantics across modalities. In certain aspects, the generated features may be considered “learned representations” in that they are not directly measured but rather inferred by the model based on the input observations and the learned feature extraction and fusion mechanisms. In other cases, the generated features may correspond to physical quantities or semantic concepts that are not explicitly represented in the raw sensor data but can be derived through the model's learned transformations. Note that other input data and/or output data may be used in addition to or instead of the examples described herein, depending on the specific application and the available sensors.

In certain aspects, a model server 650 may perform any of various ML model lifecycle management (LCM) tasks for the first computing device 602 and/or the second computing device 604. The model server 650 may operate as the model training host 502 and update the ML model 630 using training data. In some cases, the model server 650 may operate as the data source 506 to collect and host training data, inference data, and/or performance feedback associated with an ML model 630. In certain aspects, the model server 650 may host various types and/or versions of the ML models 630 for the first computing device 602 and/or the second computing device 604 to download.

In some cases, the model server 650 may monitor and evaluate the performance of the ML model 630 that utilizes modality-specific and modality-generic feature generation to trigger one or more lifecycle management (LCM) tasks. For example, the model server 650 may determine whether to activate or deactivate the use of a particular fusion model at the first computing device 602 and/or the second computing device 604, based on factors such as the accuracy requirements, computational budget, and energy constraints of each device. The model server 650 may then provide instructions to the respective devices to manage their model usage accordingly. In some cases, the model server 650 may determine whether to switch to a different variant of the fusion model at the first computing device 602 and/or the second computing device 604, based on changes in the operating conditions or performance objectives. For instance, the model server may instruct a device to switch from a complex model with high accuracy to a simpler model with lower latency when the battery level falls below a threshold. In yet further examples, the model server 650 may act as a central coordinator for collaborative learning of fusion models across multiple devices, using techniques such as federated learning to train a global model from locally-computed updates while preserving data privacy.

### Example Artificial Intelligence Model

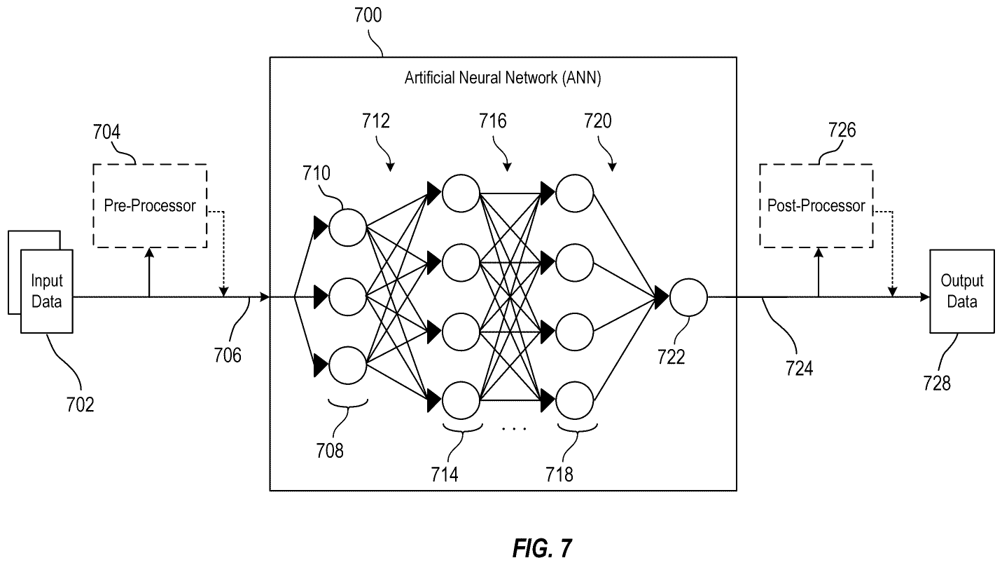

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 512 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 5 and 6. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 700 of FIG. 7.

As part of the development process for machine learning models that generate modality-specific and modality-generic features, relevant training data must be gathered or generated. For example, training data may include ground truth labels for the desired output features (e.g., modality-specific features, modality-generic features), as well as corresponding input observations (e.g., images, LiDAR data, audio data). This data can be used to train the model to accurately extract informative features from each modality and combine them effectively for the given task. In certain instances, the training data may originate from sensors on user devices (e.g., smartphones, robots, vehicles), dedicated data collection equipment (e.g., multi-sensor rigs), or public datasets. In some cases, the training data may be aggregated from multiple sources to cover a wide range of scenarios and improve model generalization. For example, crowdsourcing platforms or online databases may be leveraged to gather diverse examples for training feature extraction models. In another example, training data may be generated synthetically using simulation engines or generative models to augment real-world samples. The training data collection process can be performed offline, resulting in a static dataset for batch training, or online, where new samples are continuously incorporated into the model training pipeline. For example, an embedded system may periodically upload new training samples gathered during operation to a server, which then fine-tunes the feature extraction model using online learning techniques. For offline training, data collection and model updates can occur at a central location (e.g., a datacenter) or be distributed across multiple nodes (e.g., a sensor network). For online training, the model may be adapted locally on each device or by a remote server that receives streaming data from the devices.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training of machine learning models that generate modality-specific and modality-generic features on data distributed across multiple devices or organizations, without the need to centralize the data or the training process. Federated learning is particularly useful when the training data is sensitive or subject to privacy constraints, or when it is impractical, inefficient, or expensive to gather all the data in one place. In the context of feature extraction tasks, for example, federated learning may be used to improve model performance by allowing it to learn from a wide range of environments and conditions. For instance, a feature extraction model for autonomous vehicles may be trained on data collected from a large number of vehicles, each with its own sensor configuration and operating domain, to improve generalization. With federated learning, each device may receive a copy of the model and perform local training using its own data to capture device-specific patterns. The devices then send only the updated model parameters (e.g., weights and biases) to a central server, without revealing the raw data. The server aggregates the contributions from all devices and updates the global model, which is then redistributed to the devices for the next round of local training. This process is repeated iteratively until the feature extraction model achieves satisfactory performance across all participating devices. By enabling collaborative learning while keeping data localized, federated learning allows the development of powerful feature extraction models that can leverage diverse datasets without compromising privacy or security.

In some implementations, one or more devices or services may support processes relating to the usage, maintenance, activation, and reporting of machine learning models that generate modality-specific and modality-generic features. In certain instances, all or part of the training data or the trained model may be shared across multiple devices to provide or improve the feature extraction capabilities. For example, a vehicle with multiple sensors may share its data with another vehicle having only a single sensor, enabling the latter to train a feature extraction model that can handle multi-modal inputs. In some cases, signaling mechanisms may be employed to communicate the capabilities and requirements for performing specific functions related to feature extraction models, such as the supported input and output formats, the available computational resources, or the ability to collect and share training data. These models may be used to support various applications, such as object detection, segmentation, tracking, or prediction and planning. The deployment of feature extraction models may occur at different levels of a system architecture, such as on individual devices (e.g., smartphones, vehicles), edge servers (e.g., base stations, access points), or cloud platforms, depending on factors such as latency requirements, data privacy concerns, and resource availability. By leveraging the disclosed techniques for generating modality-specific and modality-generic features, these models can provide high-quality representations while operating under the constraints of each deployment scenario.

### Example Operations for Obtaining Modality-Specific and Modality-Generic Features

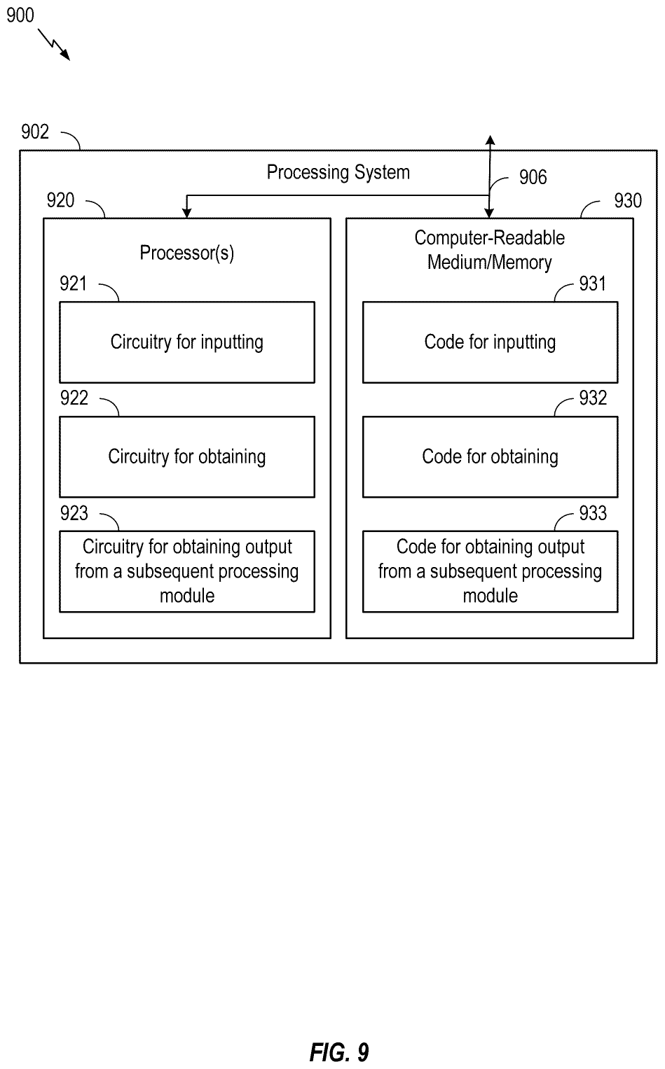

In one aspect, method 800, or any aspect related to it, may be performed by an apparatus, such as processing system 900 of FIG. 9, which includes various components operable, configured, or adapted to perform the method 800. In certain aspects, method 800, or any aspect related to it, may be performed by the processing system 900 for processing multi-modal data to obtain a modality-specific and/or a modality-generic feature of FIG. 1, the fusion model 106 of FIG. 1 and FIG. 2, the attention mechanism 212 of FIG. 2 and FIG. 3, and/or the modality feature extractor 404 of FIG. 4.

Method 800 begins at block 802 with inputting a first set of features and a second set of features into a fusion model.

Method 800 then proceeds to block 804 with obtaining as output from the fusion model: at least one of: a first set of modality-specific features associated with a first modality; or a second set of modality-specific features associated with a second modality; and a set of modality-generic features associated with both the first modality and the second modality. In some aspects, the first set of modality-specific features includes one or more first types of features that are distinct from one or more second types of features included in the second set of modality-specific features.

Method 800 then proceeds to block 806 with obtaining, as output from one or more subsequent processing modules, a result based on the one or more of the first set of modality-specific features, the second set of modality-specific features, or the set of modality-generic feature.

In certain aspects, method 800 further includes obtaining the output from the fusion model, which comprises: generating, by a cross-attention mechanism, a first set of attention weights based on the first set of features and the second set of features; and generating the first set of modality-specific features based on a complement of the first set of attention weights applied to the first set of features.

In certain aspects of method 800, obtaining the output from the fusion model further comprises: generating, by the cross-attention mechanism, a second set of attention weights based on the first set of features and the second set of features; and generating the second set of modality-specific features based on a complement of the second set of attention weights applied to the second set of features.

In certain aspects of method 800, obtaining the output from the fusion model further comprises generating the set of modality-generic features based on the first set of attention weights applied to the first set of features and the second set of attention weights applied to the second set of features.

In certain aspects of method 800, the complement for the first set of attention weights represents an inverse relationship between the first set of attention weights and a residual attention capacity.

In certain aspects of method 800, generating the first set of modality-specific features comprises generating the complement for the first set of attention weights as a difference between each attention weight in the first set of attention weights and an attention capacity.

In certain aspects of method 800, the attention capacity represents a maximum attention value that can be assigned to each feature in the first set of features.

In certain aspects of method 800, generating the first set of attention weights comprises: obtaining a set of keys based on the first set of features associated with the first modality; obtaining a set of queries based on the second set of features associated with the second modality; and computing the first set of attention weights based on a similarity function applied to the set of queries and the set of keys.

In certain aspects of method 800, the similarity function is configured to compute a dot product between each query and each key.

In certain aspects of method 800, obtaining the output from the fusion model comprises generating the set of modality-generic features based on fusion of the first set of features and the second set of features.

In certain aspects, method 800 further includes: inputting a third set of features associated with a third modality into the fusion model; and obtaining, as output from the fusion model, a third set of modality-specific features associated with the third modality and an updated set of modality-generic features associated with the first modality, the second modality, and the third modality.

In certain aspects, method 800 further includes: inputting data associated with the first modality into a first feature extractor; obtaining, as output from the first feature extractor, the first set of features; inputting data associated with the second modality into a second feature extractor; and obtaining, as output from the second feature extractor, the second set of features.

In certain aspects of method 800, the first feature extractor includes a neural network model having been trained to extract features from data associated with the first modality, and the second feature extractor includes a second neural network model having been trained to extract features from data associated with the second modality.

In certain aspects, method 800 further includes acquiring one or more images associated with a visual modality using one or more image sensors.

In certain aspects of method 800, the one or more image sensors is integrated into one of a vehicle, an extra-reality device, or a mobile device.

In certain aspects of method 800, the first modality includes a visual modality and the second modality includes a sensor modality.

In certain aspects, method 800 further includes acquiring point cloud data associated with the second modality using one or more LiDAR sensors, wherein the point cloud data includes a three-dimensional representation of a scene, and wherein each point in the point cloud data represents a distance measurement from an origin point associated with the LiDAR sensor to a corresponding point in the scene.

In certain aspects, method 800 further includes at least one of sending to one or more devices, data associated with the first modality, or receiving from one or more devices, data associated with the first modality, using a modem coupled to one or more antennas and coupled to the one or more processors.

In certain aspects, method 800 further includes obtaining, as output from the one or more subsequent processing modules, a result based on the one or more of the first set of modality-specific features, the second set of modality-specific features, or the set of modality-generic features.

In certain aspects of method 800, the result is associated with one or more of object detection, segmentation, tracking, prediction, or planning.

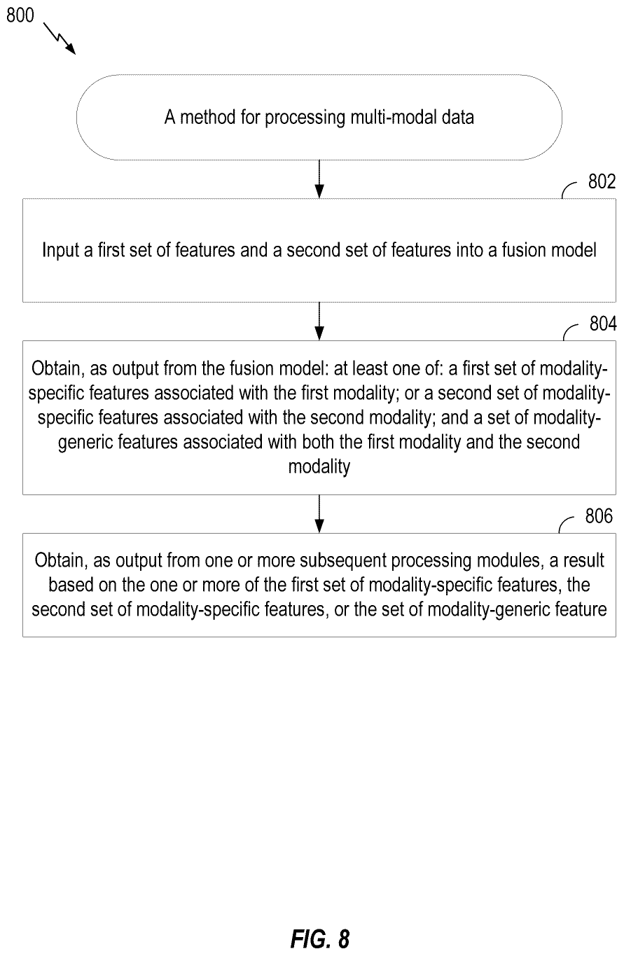

Note that FIG. 8 is just one example of a method, and other methods including fewer, additional, or alternative steps are possible consistent with this disclosure.

### Example Processing System for Obtaining Modality-Specific and Modality-Generic Features

FIG. 9 depicts aspects of an example processing system 900. The processing system 900 may be used to implement the example processing system 900 for processing multi-modal data to obtain a modality-specific and/or a modality-generic feature of FIG. 1, including the fusion model 106 of FIG. 1 and FIG. 2, the machine learning model 114 of FIG. 1, the attention mechanism 212 of FIG. 3, and/or the modality feature extractor 404 of FIG. 4. The components of these systems, such as the key/value adapter 202, attention mechanism 206, query adapter 208, attention mechanism 212, key/value adapter 214, query adapter 218, modality-generic fuser 226, attention weight calculator 308, complementary attention weight generator 310, MatMul 312, and MatMul 316 may be realized using processors, memory, and other hardware components of the processing system 900.

The processing system 900 includes a processing system 902 includes one or more processors 920. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the method 800 described with respect to FIG. 8, or any aspect related to it, including any additional steps or sub-steps described in relation to FIG. 8.

In the depicted example, computer-readable medium/memory 930 stores code (e.g., executable instructions) for inputting 931, code for obtaining 932, and code for obtaining output from a subsequent processing module 933. Processing of the code 931-933 may enable and cause the processing system 900 to perform the method 800 described with respect to FIG. 8, or any aspect related to it.

The one or more processors 920 include circuitry configured to implement (e.g., execute) the code stored in the computer-readable medium/memory 930, including circuitry for inputting 921, circuitry for obtaining 922, and circuitry for obtaining output from a subsequent processing module 923. Processing with circuitry 921-923 may enable and cause the processing system 900 to perform the method 800 described with respect to FIG. 8, or any aspect related to it.

### Example Clauses

Implementation examples are described in the following numbered clauses:

Clause 1: A method for processing multi-modal data, the method comprising: inputting a first set of features and a second set of features into a fusion model; obtaining as output from the fusion model: at least one of: a first set of modality-specific features associated with a first modality; or a second set of modality-specific features associated with a second modality, wherein the first set of modality-specific features includes one or more first types of features that are distinct from one or more second types of features included in the second set of modality-specific features; and a set of modality-generic features associated with both the first modality and the second modality; and obtaining, as output from one or more subsequent processing modules, a result based on the one or more of the first set of modality-specific features, the second set of modality-specific features, or the set of modality-generic feature.

Clause 2: The method of Clause 1, wherein obtaining the output from the fusion model comprises: generating, by a cross-attention mechanism, a first set of attention weights based on the first set of features and the second set of features; and generating the first set of modality-specific features based on a complement of the first set of attention weights applied to the first set of features.

Clause 3: The method of Clause 2, wherein obtaining the output from the fusion model comprises: generating, by the cross-attention mechanism, a second set of attention weights based on the first set of features and the second set of features; and generating the second set of modality-specific features based on a complement of the second set of attention weights applied to the second set of features.

Clause 4: The method of Clause 3, wherein obtaining the output from the fusion model comprises generating the set of modality-generic features based on the first set of attention weights applied to the first set of features and the second set of attention weights applied to the second set of features.

Clause 5: The method of any one of Clauses 2-4, wherein the complement for the first set of attention weights represents an inverse relationship between the first set of attention weights and a residual attention capacity.

Clause 6: The method of Clause 5, wherein generating the first set of modality-specific features comprises generating the complement for the first set of attention weights as a difference between each attention weight in the first set of attention weights and an attention capacity.

Clause 7: The method of Clause 6, wherein the attention capacity represents a maximum attention value that can be assigned to each feature in the first set of features.

Clause 8: The method of any one of Clauses 2-7, wherein generating the first set of attention weights comprises: obtaining a set of keys based on the first set of features associated with the first modality; obtaining a set of queries based on the second set of features associated with the second modality; and computing the first set of attention weights based on a similarity function applied to the set of queries and the set of keys.

Clause 9: The method of Clause 8, wherein the similarity function is configured to compute a dot product between each query and each key.

Clause 10: The method of any one of Clauses 1-9, wherein obtaining the output from the fusion model comprises generating the set of modality-generic features based on fusion of the first set of features and the second set of features.

Clause 11: The method of any one of Clauses 1-10, further comprising: inputting a third set of features associated with a third modality into the fusion model; and obtaining, as output from the fusion model, a third set of modality-specific features associated with the third modality and an updated set of modality-generic features associated with the first modality, the second modality, and the third modality.

Clause 12: The method of any one of Clauses 1-11, further comprising: inputting data associated with the first modality into a first feature extractor; obtaining, as output from the first feature extractor, the first set of features; inputting data associated with the second modality into a second feature extractor; and obtaining, as output from the second feature extractor, the second set of features.

Clause 13: The method of Clause 12, wherein the first feature extractor includes a neural network model having been trained to extract features from data associated with the first modality, and wherein the second feature extractor includes a second neural network model having been trained to extract features from data associated with the second modality.

Clause 14: The method of any one of Clauses 1-13, further comprising acquiring one or more images associated with a visual modality using one or more image sensors.

Clause 15: The method of Clause 14, wherein the one or more image sensors is integrated into one of a vehicle, an extra-reality device, or a mobile device.

Clause 16: The method of any one of Clauses 1-15, wherein the first modality includes a visual modality and the second modality includes a sensor modality.

Clause 17: The method of Clause 16, further comprising acquiring point cloud data associated with the second modality using one or more LiDAR sensors, wherein the point cloud data includes a three-dimensional representation of a scene, and wherein each point in the point cloud data represents a distance measurement from an origin point associated with the LiDAR sensor to a corresponding point in the scene.

Clause 18: The method of any one of Clauses 1-17, further comprising at least one of sending to one or more devices, data associated with the first modality, or receiving from one or more devices, data associated with the first modality, using a modem coupled to one or more antennas and coupled to the one or more processors.

Clause 19: The method of any one of Clauses 1-18, further comprising: obtaining, as output from the one or more subsequent processing modules, a result based on the one or more of the first set of modality-specific features, the second set of modality-specific features, or the set of modality-generic features, wherein the result is associated with one or more of object detection, segmentation, tracking, prediction, or planning.

Clause 20: One or more apparatuses, comprising: one or more memories comprising executable instructions; and one or more processors configured to execute the executable instructions and cause the one or more apparatuses to perform a method in accordance with any one of clauses 1-19.

Clause 21: One or more apparatuses, comprising: one or more memories; and one or more processors, coupled to the one or more memories, configured to cause the one or more apparatuses to perform a method in accordance with any one of Clauses 1-19.

Clause 22: One or more apparatuses, comprising: one or more memories; and one or more processors, coupled to the one or more memories, configured to perform a method in accordance with any one of Clauses 1-19.

Clause 23: One or more apparatuses, comprising means for performing a method in accordance with any one of Clauses 1-19.

Clause 24: One or more non-transitory computer-readable media comprising executable instructions that, when executed by one or more processors of one or more apparatuses, cause the one or more apparatuses to perform a method in accordance with any one of Clauses 1-19.

Clause 25: One or more computer program products embodied on one or more computer-readable storage media comprising code for performing a method in accordance with any one of Clauses 1-19.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for processing multi-modal data, the apparatus comprising:
one or more memories configured to store a first set of features associated with a first modality and a second set of features associated with a second modality; and
one or more processors coupled to the one or more memories, the one or more processors configured to:
input the first set of features and the second set of features into a fusion model;
obtain, as output from the fusion model:
at least one of:
a first set of modality-specific features associated with the first modality; or
a second set of modality-specific features associated with the second modality, wherein the first set of modality-specific features includes one or more first types of features that are distinct from one or more second types of features included in the second set of modality-specific features; and
a set of modality-generic features associated with both the first modality and the second modality; and
obtain, as output from one or more subsequent processing modules, a result based on the one or more of the first set of modality-specific features, the second set of modality-specific features, or the set of modality-generic features.

2. The apparatus of claim 1, wherein to obtain the output from the fusion model comprises to:
generate, by a cross-attention mechanism, a first set of attention weights based on the first set of features and the second set of features; and
generate the first set of modality-specific features based on a complement of the first set of attention weights applied to the first set of features.

3. The apparatus of claim 2, wherein to obtain the output from the fusion model comprises to:
generate, by the cross-attention mechanism, a second set of attention weights based on the first set of features and the second set of features; and
generate the second set of modality-specific features based on a complement of the second set of attention weights applied to the second set of features.

4. The apparatus of claim 3, wherein to obtain the output from the fusion model comprises to generate the set of modality-generic features based on the first set of attention weights applied to the first set of features and the second set of attention weights applied to the second set of features.

5. The apparatus of claim 2, wherein the complement for the first set of attention weights represents an inverse relationship between the first set of attention weights and a residual attention capacity.

6. The apparatus of claim 5, wherein to generate the first set of modality-specific features comprises to generate the complement for the first set of attention weights as a difference between each attention weight in the first set of attention weights and an attention capacity.

7. The apparatus of claim 6, wherein the attention capacity represents a maximum attention value that can assigned to each feature in the first set of features.

8. The apparatus of claim 2, wherein to generate the first set of attention weights comprises to:
obtain a set of keys based on the first set of features associated with the first modality;
obtain a set of queries based on the second set of features associated with the second modality; and
compute the first set of attention weights based on a similarity function applied to the set of queries and the set of keys.

9. The apparatus of claim 8, wherein the similarity function is configured to compute a dot product between each query and each key.

10. The apparatus of claim 1, wherein to obtain the output from the fusion model comprises to generate the set of modality-generic features based on fusion of the first set of features and the second set of features.

11. The apparatus of claim 1, wherein the one or more processors are further configured to:
input a third set of features associated with a third modality into the fusion model; and
obtain, as output from the fusion model, a third set of modality-specific features associated with the third modality and an updated set of modality-generic features associated with the first modality, the second modality, and the third modality.

12. The apparatus of claim 1, wherein the one or more processors are further configured to:
input data associated with the first modality into a first feature extractor;
obtain, as output from the first feature extractor, the first set of features;
input data associated with the second modality into a second feature extractor; and
obtain, as output from the second feature extractor, the second set of features.

13. The apparatus of claim 12, wherein the first feature extractor includes a neural network model having been trained to extract features from data associated with the first modality, and wherein the second feature extractor includes a second neural network model having been trained to extract features from data associated with the second modality.

14. The apparatus of claim 1, further comprising one or more image sensors configured to acquire one or more images associated with the first modality comprising a visual modality.

15. The apparatus of claim 14, wherein the one or more image sensors are integrated into one of a vehicle, an extra-reality device, or a mobile device.

16. The apparatus of claim 1, wherein the first modality includes a visual modality and the second modality includes a sensor modality.

17. The apparatus of claim 16, further comprising one or more LiDAR sensors configured to acquire point cloud data associated with the second modality, wherein the point cloud data includes a three-dimensional representation of a scene, and wherein each point in the point cloud data represents a distance measurement from an origin point associated with the LiDAR sensor to a corresponding point in the scene.

18. The apparatus of claim 1, further comprising a modem, coupled to one or more antennas, and coupled to the one or more processors, wherein the modem and one or more antennas are configured to at least one of send to one or more devices, data associated with the first modality, or receive from one or more devices, data associated with the first modality.

19. A method for processing multi-modal data, the method comprising:
inputting a first set of features and a second set of features into a fusion model;
obtaining as output from the fusion model:
at least one of:
a first set of modality-specific features associated with a first modality; or
a second set of modality-specific features associated with a second modality, wherein the first set of modality-specific features includes one or more first types of features that are distinct from one or more second types of features included in the second set of modality-specific features; and
a set of modality-generic features associated with both the first modality and the second modality; and
obtaining, as output from one or more subsequent processing modules, a result based on the one or more of the first set of modality-specific features, the second set of modality-specific features, or the set of modality-generic feature.

20. One or more non-transitory computer-readable media comprising executable instructions that, when executed by one or more processors, cause the one or more processors to perform operations comprising:
inputting a first set of features and a second set of features into a fusion model;
obtaining, as output from the fusion model:
at least one of:
a first set of modality-specific features associated with a first modality; or
a second set of modality-specific features associated with a second modality, wherein the first set of modality-specific features includes one or more first types of features that are distinct from one or more second types of features included in the second set of modality-specific features; and
a set of modality-generic features associated with both the first modality and the second modality; and
obtaining, as output from one or more subsequent processing modules, a result based on the one or more of the first set of modality-specific features, the second set of modality-specific features, or the set of modality-generic features.
